(19) United States
(12) Patent Application Publication
(10) Pub. No.: US 2026/0018809 A1
(43) Pub. Date: Jan. 15, 2026

(54) SYSTEM AND METHODS FOR GROUNDING ELECTRONIC COMPONENTS USING INTERCONNECTED FASTENERS

(71) Applicant: PLUME DESIGN, INC., Palo Alto, CA (US)

(72) Inventors: Ming-Tsung SU, Taipei City (TW); Chun-Wen WANG, Taoyuan City (TW); Chun Hung LIU, Taipei City (TW)

(21) Appl. No.: 18/772,380

(22) Filed: Jul. 15, 2024

(51) Int. Cl. H01R 4/64; H04B 1/034; H04B 1/3877; H04B 1/3888

(52) U.S. Cl. CPC H01R 4/64; H04B 1/034; H04B 1/3877; H04B 1/3888

(57) ABSTRACT

The disclosure describes an interlocking grounding fastener system for a compact electronic device. In some embodiments, the system includes a first grounding fastener and a second grounding fastener configured to create a low-impedance electrical grounding connection between one or more of an antenna, a heatsink, a middle heat spreader, a bottom heat spreader, and a PCB. The first grounding fastener includes a driver engagement recess and/or threads for secure attachment to the second grounding fastener, while the second grounding fastener includes a shank with both fastening and non-fastening portions in some embodiments. These fasteners create an interlocking grounding fastener system that electrically couples the heatsink, the middle heat spreader, and the bottom heat spreader to form a grounding framework. In some embodiments, the grounding framework ensures efficient signal radiation and reception, as well as a robust grounding path for the antenna and/or PCB.

### FIELD OF THE DISCLOSURE

The present disclosure relates to grounding electrical components. More particularly, the present disclosure relates to a system and methods for securing and grounding multiple components within an electronic device using interconnected fasteners.

### SUMMARY OF THE DISCLOSURE

Wi-Fi networks, also known as Wireless Local Area Networks (WLAN), are now prevalent in almost all settings. People use them at home, at work, and in public places like schools, cafes, and parks. Wi-Fi offers great convenience by eliminating cables and allowing for mobility. The range of applications running over Wi-Fi keeps expanding, with current uses including video streaming, audio streaming, phone calls, video conferencing, online gaming, and security camera feeds. Additionally, traditional data services such as web browsing, file transfers, disk backups, and numerous mobile apps are often used simultaneously. Wi-Fi has become the primary means of connecting user devices to the Internet in homes and other locations, with the majority of connected devices relying on Wi-Fi for network access. Consequently, Wi-Fi access devices, specifically Wi-Fi Access Points (APs), are installed in a distributed manner within a location such as a home or office.

The trend in consumer electronics favors aesthetically pleasing, compact hardware. For example, a distributed Wi-Fi system comprises several Wi-Fi APs placed throughout a location like a residence. However, distributing multiple APs around a house necessitates that these devices be small, attractive, and free from visible, unattractive vent holes, demanding unique industrial solutions. These small APs with appealing, compact electronic devices present significant challenges regarding the grounding of various electronic components.

Grounding electronic components in a compact electronic device presents several challenges that can impact the performance, reliability, and manufacturability of the device. One issue is the limited space available for creating effective ground paths. In compact electronic devices, the density of components is high, which can lead to insufficient separation between ground and signal traces. This proximity can cause electromagnetic interference (EMI), signal degradation, and increased noise, ultimately affecting the device's overall functionality.

Additionally, achieving a low impedance ground path is more difficult in a confined space, as the shorter and narrower traces that are often necessary can increase resistance and inductance. Thermal management also becomes more complex, as smaller devices provide fewer opportunities for heat dissipation, potentially leading to overheating and failure of ground connections. Furthermore, ensuring robust mechanical connections and reliable solder joints is more challenging in a compact device due to the reduced area for pads and vias, increasing the risk of connectivity issues over time.

Therefore, there is a need for a grounding system that maintains the integrity and performance of electronic components in compact electronic devices.

Accordingly, as discussed herein. In some embodiments, the system includes a compact electronic device that functions as a wireless Access Point (AP). The AP includes a housing with multiple sides adjacent to a base portion. The base houses various components including a fan module, a Printed Circuit Board (PCB), one or more Wi-Fi radios, and/or a power supply. The AP also features an electrical plug connected to the power supply, extending from the bottom for insertion into an electrical outlet, providing both power and physical support for the AP. Additionally, the AP includes multiple vents hidden from view when the device is plugged into the outlet.

In some embodiments, the compact electronic device features an outer plastic housing and an inner casing, and includes components that support both higher and lower voltage operations within a single structure. In some embodiments, the system includes a single fan configured to draw air from outside the housing and expel the air through exhaust vents in the housing. The inner casing is configured to isolate specific electrical components from metal parts to meet safety standards.

Moreover, the compact electronic device described herein has various modules, including a fan module with at least a single fan, and components connected to an AC electrical plug that provides power and physical stability when plugged into an outlet. One or more plastic chambers within the inner casing protects various electrical components from electromagnetic interference.

In some embodiments, the outer plastic housing comprises a removable top cover attached to a base portion, forming a gap that allows air to flow into and/or out of the housing. In some embodiments, the gap between the top cover and the base include multiple intake air vents and one exhaust air vent, with a bottom section featuring additional intake vents. An additional exhaust vent under the gap exhaust vent increases airflow out of the AP.

Electrical components such as the antenna and printed circuit board (PCB) each require both electrical grounding and a fastening mechanism to hold them in place. The interlocking grounding faster system described herein includes grounding fasteners that provide electrical and physical connections between various components such as the antenna, heat sink, middle heat spreader, bottom heat spreader, and PCB, as well as to each other.

In some embodiments, the grounding system includes a first grounding fastener configured to couple to a second grounding fastener. In some embodiments, the first grounding fastener electrically and physically couples to the antenna, and the second grounding fastener electrically and physically couples to one or more of the first grounding fastener, the antenna, the heat sink, the middle heat spreader, the bottom heat spreader, and the PCB. The interlocking grounding fastener(s) create a low-impedance connection, ensuring efficient signal radiation and reliable grounding.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 shows a compact electronic device configured to be plugged into an electrical outlet according to some embodiments of the present disclosure;

FIG. 2 illustrates a perspective view of the compact electronic device according to some embodiments of the present disclosure;

FIG. 3 shows air intake paths through an air gap according to some embodiments of the present disclosure;

FIG. 4 depicts internal features of the system according to some embodiments of the present disclosure;

FIG. 5 shows air flow through internal portions of the system according to some embodiments of the present disclosure;

FIG. 6 illustrates features of the fan module and heat sink according to some embodiments of the present disclosure;

FIG. 7 shows various apertures in the heat sink according to some embodiments of the present disclosure;

FIG. 8 shows an antenna ring that includes a plurality of antennas according to some embodiments of the present disclosure;

FIG. 9 illustrates a section view showing interconnecting grounding fasteners according to some embodiments of the present disclosure;

FIG. 10 depicts details of the interconnecting grounding fasteners according to some embodiments of the present disclosure;

FIG. 11 shows show details of an interlock recess according to some embodiments of the present disclosure;

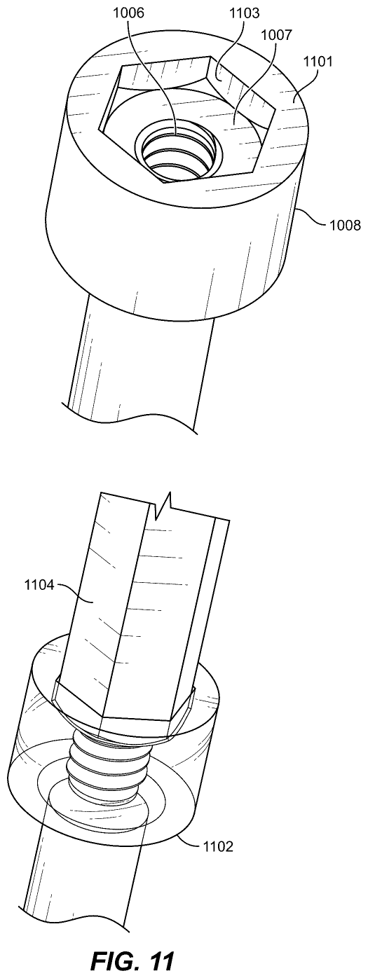

FIG. 12 illustrates a side view of a second grounding fastener according to some embodiments of the present disclosure;

FIG. 13 shows the example dimensions of the interlocked grounding fasteners and various components according to some embodiments of the present disclosure; and

FIG. 14 depicts a technical drawing of an example grounding fastener according to some embodiments of the present disclosure.

### DETAILED DESCRIPTION

The disclosure pertains to systems and methods for grounding components in compact electronic devices, such as wireless access devices. These devices, which can include Wi-Fi Access Points (APs) in distributed Wi-Fi systems, for example, feature a small form factor with multiple sides, direct plug-in capability to an electrical outlet, and internal components such as a power supply, PCB, antennas, and at least one fan, according to some embodiments. To accommodate this configuration, the electronic device incorporates a unique form factor and airflow layout that includes an air gap structure utilizing the same openings for both intake and exhaust and/or a layered structure for directing airflow between layers.

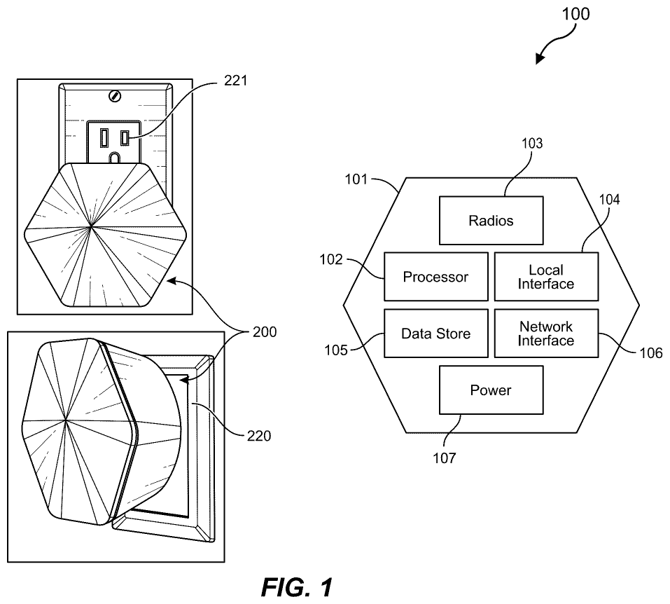

Referring to the figures, various illustrations depict an non-limiting electronic device 100 for illustration purposes. In some embodiments, the electronic device 100 functions as a wireless Access Point (AP) 200 or equivalent wireless access device. As shown in FIG. 1 the AP 200 features a form factor 101 that allows it to be plugged directly into an electrical outlet 220. In some embodiments, the AP is compact, meaning the AP is configured to not obstruct outlets and/or is weighted to be supported by an outlet 220 and/or plug 221. While described herein as a wireless access point 200, it is understood that the systems and methods described here can be applied to any type of electronic device, including sensors, cameras, Internet of Things (IoT) devices, media players, and cell phones, as non-limiting examples.

In some embodiments, the physical form factor 101 includes a processor 102, multiple radios 103, a local interface 104, a data store 105, a network interface 106, and/or a power supply 107, each of which require grounding. FIG. 1 simplifies the compact electronic device 100, and some embodiment may have additional components and processing logic.

In some embodiments, the form factor 101 is ideal for distributing many access points throughout a residence. The processor 102 executes software instructions and can be a custom or commercially available CPU, a semiconductor-based microprocessor, a chipset, and/or any device for executing software instructions. When operational, the processor 502 executes software stored in memory or the data store 105, communicates data to and from these storage elements, and generally controls the access point's operations.

In some embodiments, the radios 103 enable wireless communication, operating according to the IEEE 802.11 standard, for example, and include connections for communications on a Wi-Fi system. The access point 200 can support multiple radios for different links, such as backhaul and client links. Some embodiments support dual-band operation with 2.4 GHz and 5 GHz 2×2 MIMO 802.11b/g/n/ac radios, providing operating bandwidths of 20/40 MHz for 2.4 GHz and 20/40/80 MHz for 5 GHz. The access points may also support IEEE 802.11AC1200 gigabit Wi-Fi.

The local interface 106 enables local communication with the access point 200, either wired or wirelessly (e.g., Bluetooth®). The data store 105 stores data and may include volatile memory (e.g., RAM), nonvolatile memory (e.g., ROM, hard drive, CDROM), and/or combinations thereof, incorporating various types of storage media.

The network interface 106 provides wired connectivity, such as via the RJ-45 ports 205, enabling communication with a modem/router and local connectivity to Wi-Fi client devices. This can provide network access to devices without Wi-Fi support. The network interface 106 may include an Ethernet card or adapter, with connections for appropriate network communications. The processor 102 and the data store 106 may include software and/or firmware controlling the access point's operation, data management, and/or memory management.

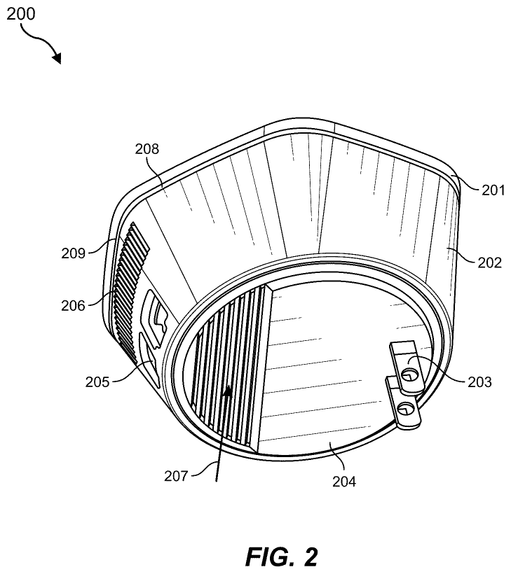

As shown in FIG. 2, the AP 200 includes a top cover 201 over a base 202 and an electrical plug 203 protruding from the bottom portion 204 of the base 202. In some embodiments, the base 202 includes RJ-45 ports 205 for data connectivity, such as via Ethernet cables. The base 202 may also include other types of wired ports, which are not illustrated. Additionally, the base 202 features various openings for air intake and exhaust, including an exhaust vent(s) 206 on a side of the base 202, an intake vent(s) 207 on the bottom portion 204, and an air gap 208 between the top cover 201 and the base 202.

The exhaust vent 206 and intake vent 207 are configured to be hidden when the compact electronic device 100 is plugged into an electrical outlet (see FIG. 1). That is, these openings are not observable by someone looking at the device when it is plugged in. The electrical plug 203 serves dual functions: providing electrical connectivity to a corresponding outlet and mechanically supporting the compact electronic device 100 while it is plugged in. In some embodiments, the bottom portion 204 is configured to be positioned adjacent to a structure (e.g., a wall) with an electrical outlet. In some embodiments, the intake vent 207 is recessed from the bottom portion 204 to create an airflow gap when the bottom portion is in contact with the outlet 102.

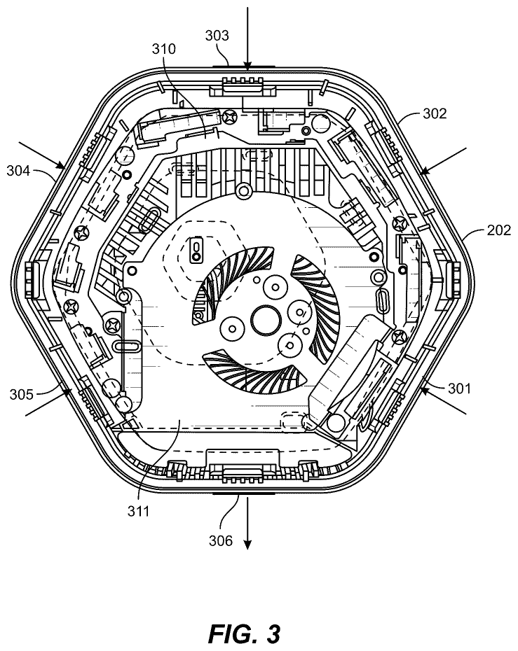

As shown in FIG. 3, the base 202 can have a plurality of sides 301, 302, 303, 304, 305, and 306. In some embodiments, the form factor 101 includes a hexagonal perimeter, i.e., six sides, but other configurations are possible. In some embodiments, the compact electronic device 100 utilizes a plurality of different sides for air intake. FIG. 3 also illustrates the airflow, with air intake (cold or room temperature air) shown at sides 301, 302, 303, 304, and 305, and air exhaust (warm air) at side 306.

In some embodiments, the exhaust vent 206 and the air gap exhaust 209 on side 306 are used for hot air exhaust, while the intake vent 207, as well as the air gap 208 on sides 301, 302, 303, 304, and 305, are used for cold (i.e., ambient) air intake. A heat sink 501 and/or the fan module 601 is configured to cooperate with one or more protrusions 401 extending from the top cover 201 to separate the air intake and exhaust portions of the air gap 208. The heat sink 501, according to some embodiments, is made of an electrical and/or thermally conductive material, and forms part of the grounding and fastening system as described further below.

In some embodiments, the top cover 201 is configured to couple (e.g., snap) onto the base 202, forming an air gap 208 between the top cover 201 and the base 202. In some embodiments, the air gap 208 includes a continuous space (e.g., no interrupting protrusions) about a perimeter of the AP 200 along each side 301-306. In some embodiments, the one or more protrusions 401 divide the air intake and exhaust, with double-walled sections for improved isolation and resistance to air leakage, creating a thermal isolating region between intake (cool air) and exhaust (hot air).

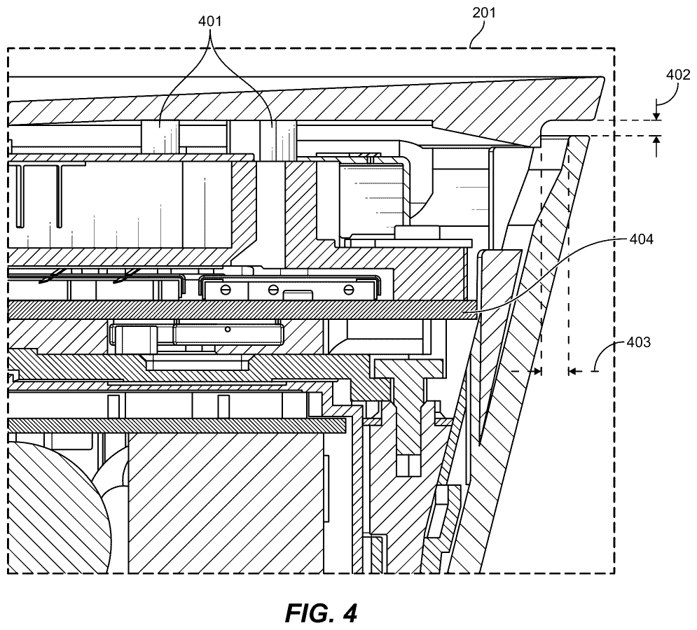

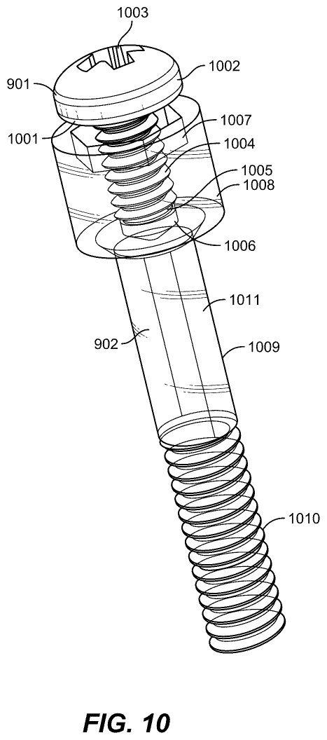

FIG. 4 illustrates the AP 200 in a cross-section, showing internal components in accordance with some embodiments. With reference to FIG. 10, the top cover 201 is secured in place with the base 202 via protrusions 401, which may include a tongue and groove mechanism and/or one or more snap fittings as non-limiting examples. Referring back to FIG. 4, the protrusions 401 are separated and/or recessed from both an air gap outer opening 402 and an air gap inner opening 403 so that the air gap 208 appears continuous when the system is assembled. A power supply 801 powers all components and is connected to the electrical plug 203.

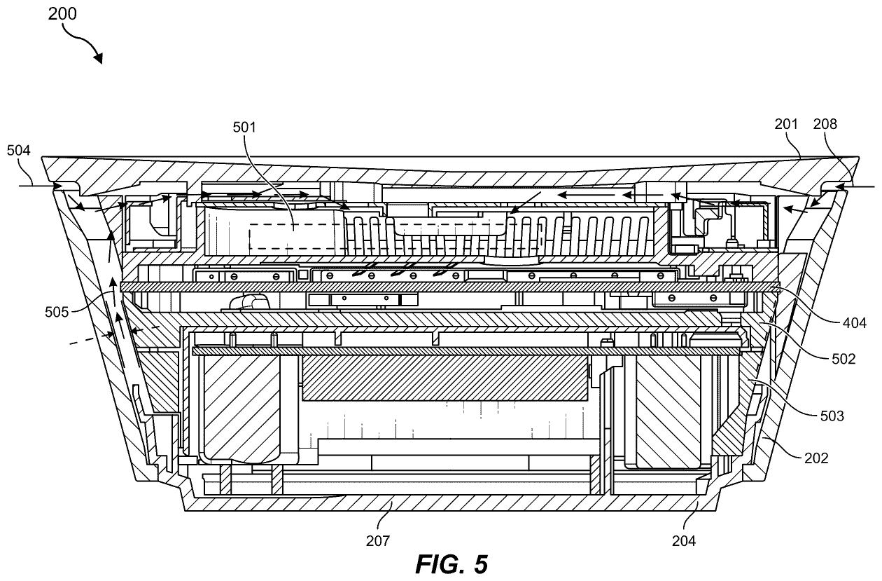

FIG. 5 depicts a cross-sectional view of the AP 200, showing various components and features of the system. In some embodiments, the AP 200 includes one or more of a top cover 201, a heat sink 501, a PCB 404, a middle heat spreader 502, a bottom heat spreader 503, a base 202, and a bottom portion 204. In some embodiments, the PCB 404 includes various electronic components that require grounding, such as Wi-Fi chipsets.

As shown in FIG. 5, cool air is fed through the air gap 208 through the air gap intake path 504, represented by arrows, and a sidewall intake path 505 from which cool air is drawn by vacuum force through intake vent 207. In some embodiments, one or more sidewall intake paths 505 range from 1 millimeter (mm) to 4 mm in width, where 2 mm has been found to be effective at maintaining the middle heat spreader temperature below 70° Celsius (C), and/or a surface temperature of the base 202 below 50° C., when ambient air temperature is at or below 25° C. Sidewall intake paths may vary in width to allow more airflow or to restrict airflow such that higher heat producing components receive more air.

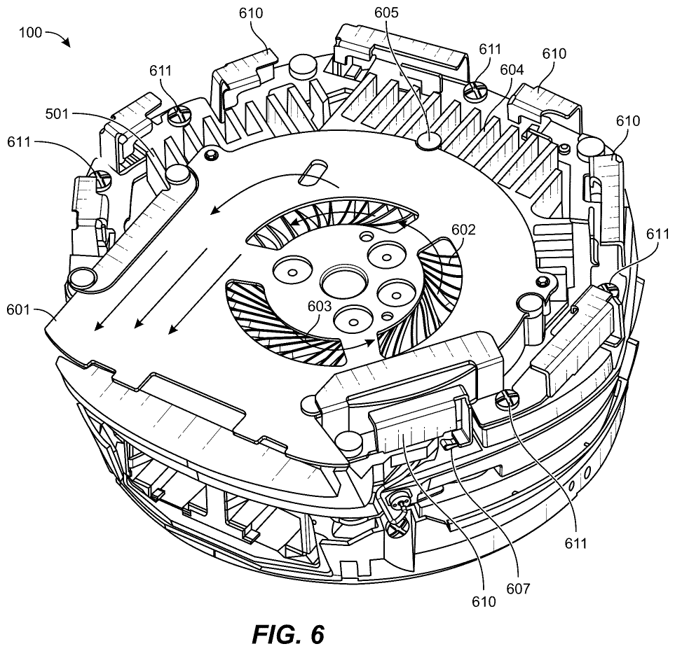

FIG. 6 illustrates the compact electronic device 100 with the top cover 201 and base 202 removed in accordance with some embodiments. Straight arrows indicate airflow toward the exhaust vent 206 and/or air gap exhaust 209; curved arrows show a rotation of fan blades 602, which is configured to draw in air from the air gap 208 and intake vent 207 using the vacuum created by the fan intake 603. The vacuum created by fan module 601 draws air into the air gap intake 504 and sidewall intake path 505 removing heat from the internal components. The drawn-in air is mixed with the air from the air gap 208, where it passes over and/or through one or more fins 604. This combined airflow from multiple directions provides a more even transfer of heat from the heat sink 501. In some embodiments, the fan module 601 is configured to be coupled to the heatsink 501 via one or more fasteners 605 (e.g., screws). The cold air drawn in from the gap 208 is configured to reduce the temperature of the air coming from intake vent 207 providing greater heat transfer for the heatsink 501, which is configured to remove heat from the CPU components. In some embodiments, the system includes an antenna ring 610 which is grounded and/or fastened to the heat sink 501 using one or more (interlocking) grounding fasteners 611 as further described herein.

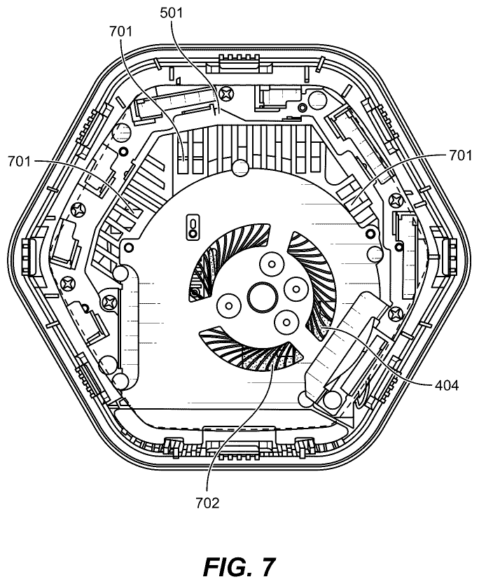

FIG. 7 shows a top view of the heatsink 501 above the PCB 404. The fan module 302 includes fan blades 303 (represented by dashed lines in FIG. 5). In some embodiments, the heat sink includes one or more fin apertures 701 configured to drawn in air from a gap between the PCB 404 and the heat sink 501. In some embodiments, the heatsink 501 includes a fan aperture 702. In some embodiments, the positioning of the fan aperture 702 over the fan blades 602 causes airflow into the PCB gap further removing heat from one or more CPU components 801 (e.g., chipsets).

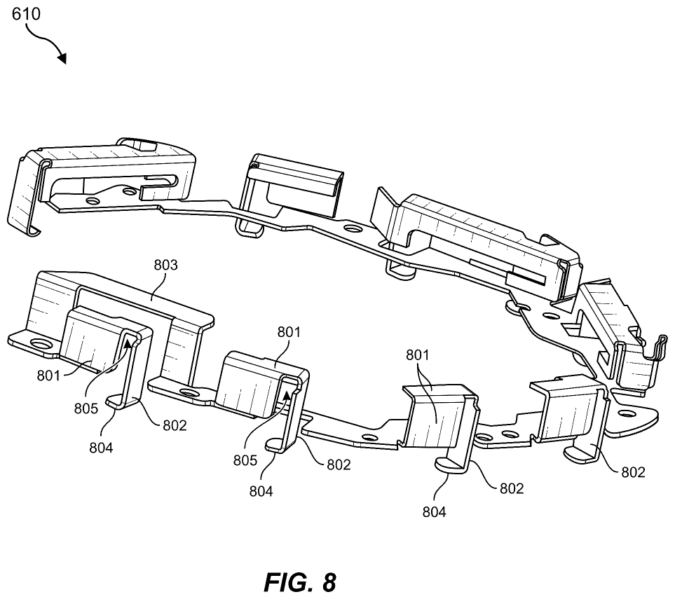

FIG. 8 is a perspective diagram of the antenna ring 610 according to some embodiments. In some embodiments, the antenna ring 610, which comprises a plurality of individual antennas, includes various ground planes 801, elongate portions 802, and bridge members 803. The elongate portions 802 further include flanges 804 which act as a feeding point for each antenna. The antenna ring 610 forms a plurality of closed ends (shorting ends) 805 which make up the closed ends of the plurality of slot antennas when the various components are assembled.

In some embodiments, the ground planes 801 are configured to emulate an infinite ground sheet as called for by a slot antenna. The various ground planes 801 extend from the edges of the slot antenna and may extend straight or be folded to conserve space. The various ground planes 801 are large enough as to allow the slot antenna to have adequate performance while conserving space inside of the wireless device. One or more bridge members 803 are configured to link the plurality of ground planes 801 and elongate portions 802, allowing the antenna ring 610 to be installed as a single component.

The elongate portions 802 extend to create one or more slots while provide a feeding point via the flanges 804. The flanges 804 are configured to be positioned in relation to a PCB as to receive a feeding interface from the PCB, such as a spring clip 607, for example.

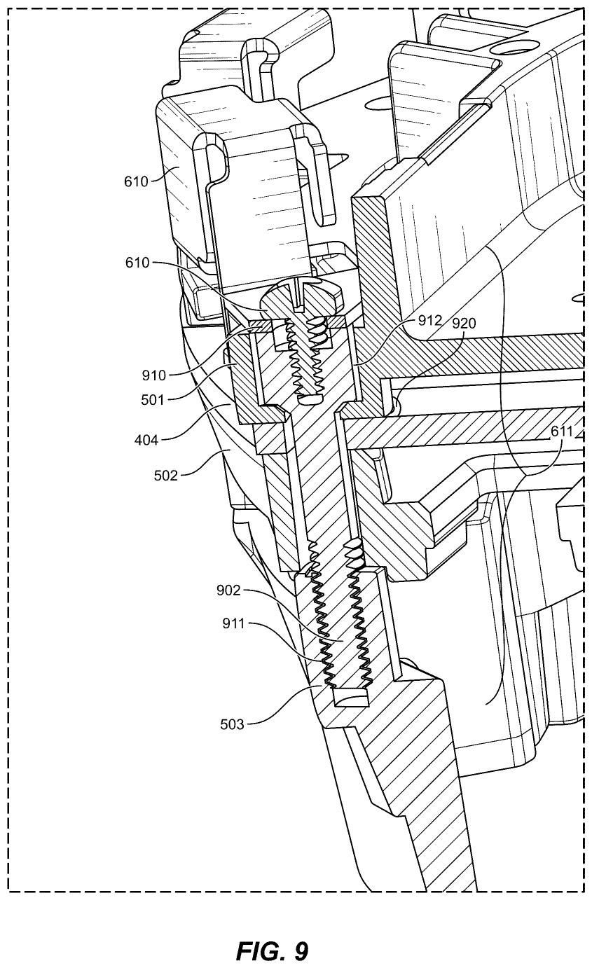

Referring now to FIG. 9, at least part of the grounding for the antenna ring 610 and/or PCB 404, as well as any other electrical component described herein, is provided by one or more interlocking grounding fasteners 611 which form part the system according to some embodiments. In some embodiments, a first grounding fastener 901 is configured to couple to a second grounding fastener 902. In some embodiments, the first grounding fastener 901 is configured pass through an antenna fastener aperture on the antenna ring 610. In some embodiments, the first grounding fastener 901 is configured to electrically couple to the antenna ring 610, which may be the result of the underside 1001 of the first fastener head 1002 being in physical contact with a surface of the antenna ring 610. Although the system is described as providing a ground for the antenna ring 610, which comprises a plurality of antennas, the system is suitable for use with a single antenna structure, and/or a plurality of individual antennas as well.

In some embodiments, the first grounding fastener 901 is configured to electrically and/or physically couple to the second grounding fastener 902. In some embodiments, the second grounding fastener 902 is configured to electrically and/or physically couple to one or more of the first grounding fastener 901, the antenna ring 610, the heat sink 501, the middle heat spreader 502, the bottom heat spreader 502, and/or the PCB 404. While in this non-limiting example a single second grounding fastener 902 is physically and electrically coupled to all of these components, in some embodiments, the second grounding fastener 902 includes two or more grounding fasteners each interconnected at a location proximate one of the heat sink 501, the middle heat spreader 502, the bottom heat spreader 502, and/or the PCB 404, depending on the location of fastener apertures in different components. In some embodiments, the PCB comprises a grounding contact 920 configured to electrically couple to the heat sink 501, proximate the interlocking grounding fastener 611, and/or a non-fastening portion 1011 of the interlocking grounding fastener 611.

In some embodiments, the interlocking fasteners 611 are configured to create a low-impedance connection to the heat sink 501, the middle heat spreader 502, and/or the bottom heat spreader 502, which are each both electrically and thermally conductive, providing a grounding framework for the antenna ring 610 and PCB 404, as well as various other electrical components. In some embodiments, the interconnecting grounding fasteners 611 act as short, thick traces to connect the antenna ring 610 to the grounding framework, ensuring that the antenna ring 610 can efficiently radiate and receive signals, and/or the PCB has a reliable low-impedance path for grounding.

FIG. 10 shows details of the first grounding fastener 901 interlocking with the second grounding fastener 902 in accordance with some embodiments. In some embodiments, the first fastener 901 includes a driver engagement recess 1003 (e.g., Phillips, Slotted, Torx, Hex, Allen, Pozidriv, Square, etc.) configured to engage with a fastener driver to enable the fastener 901 to be manipulated (e.g., rotated) in this non-limiting example. In some embodiments, the first grounding fastener 901 comprises one or more threads 1004 configured to engage with the second fastener 902 and/or the antenna fastener aperture 910.

In some embodiments, a length of the shank 1005 of the first grounding fastener 901 is less than or equal to a shank recess portion 1006 of an interlock recess 1007 within a second fastener head 1008 of the second grounding fastener 902. In some embodiments, the second grounding fastener 902 includes a second fastener shank 1009, which is configured to make electrical and/or physical contact with the antenna ring 610, the heat sink 501, the middle heat spreader 502, the bottom heat spreader 502, and/or the PCB 404, when the system is assembled. In some embodiments, the second fastener shank 1009 includes a fastening portion 1010 (e.g., threaded portion, engagement protrusions, etc.) and a non-fastening portion 1011. In some embodiments, one or both of the fastening portion 1010 and the non-fastening portion 1011 are configured to make electrical contact with one or more components.

In some embodiments, the system is configured such that the fastening portion 1010 engages a grounding fastener receiver 911 in the bottom heat spreader 503 when assembled. In some embodiments, the system is configured such that the non-fastening portion 1011 (e.g., non-threaded portion) passes through an aperture in each of the heat sink 501, PCB 404, and/or 502. In some embodiments, the fastening portion 1010 is configured to engage a grounding faster receiver in the middle heat spreader 502 when assembled.

In some embodiments, the second fastener head 1008 includes one or more of a flat top surface 1101 and a flat bottom surface 1102. In some embodiments, the flat top surface 1101 is configured to engage a flat portion of the antenna ring 610 when assembled, as shown in FIG. 9. In some embodiments, the flat bottom surface 1102 is configured to engage a flat portion of a heat sink fastener recess 912 within the heat sink 501, forcing the heat sink 501, the middle heat spreader 502, the bottom heat spreader 502, and/or the PCB 404 against each other, and locking each into a fixed position. In some embodiments, a depth of the heat sink fastener recess 912 is substantially the same as a length of the second fastener head 1008, such that the heat sink fastener recess 912 is configured to enable the second fastener head 1008 to contact the flat portion of the heat sink fastener recess and the antenna ring 610 simultaneously, while the antenna ring 610 is in contact with the heat sink 501 proximal the heat sink fastener recess 912. In some embodiments, the second grounding fastener 902 interlock recess 1007 includes a driver engagement recess 1103 (e.g., Phillips, Slotted, Torx, Hex, Allen, Pozidriv, Square, etc.) located above the shank recess 1006, which in this non-limiting example is configured to engage with a fastener driver in the form of an Allen wrench 1104.

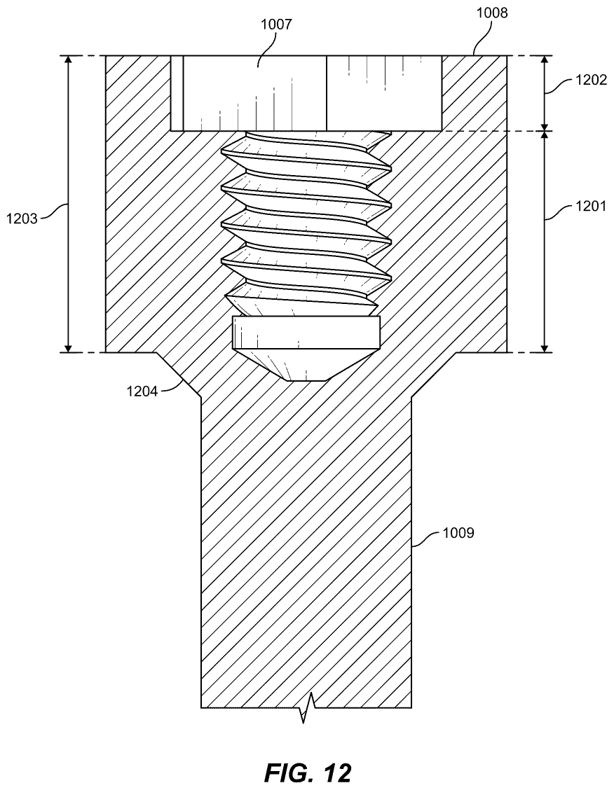

FIG. 12 shows a side perspective of the second faster head 1008 in accordance with some embodiments. In some embodiments, a shank depth 1201 is greater than a depth 1202 the driver engagement recess 1103. In some embodiments, a depth 1203 of the interlock recess 1007 is greater than a length of the second fastener head 1008. In some embodiments, the second fastener shank 1009 includes a chamfer 1204 which is configured to reduce stress on the second fastener head 1008 while enabling the shank depth 1201 to extend below the second fastener head 1008.

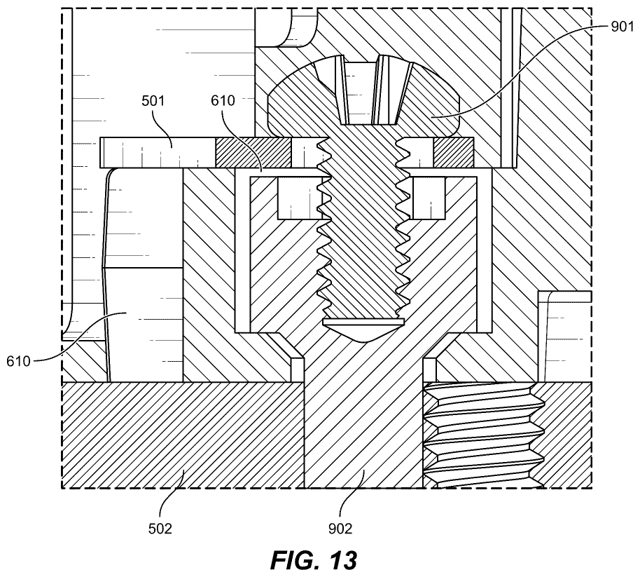

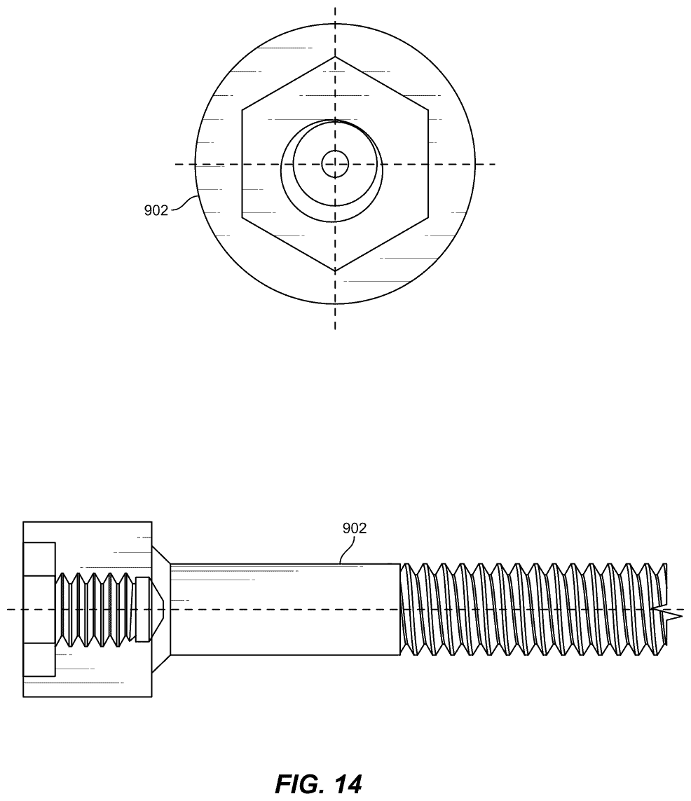

FIG. 13 shows a side assembled view of the system according to some embodiments. In some embodiments, non-limiting example measurements of the first grounding fastener 901 are presented along with measurements of the heat spreader 501 and antenna ring 610. FIG. 14 depicts a technical drawing with details of the second grounding fastener 902 to further aid those of ordinary skill in making and using the system.

While shown as a compact electronic device 100, it is understood that the system is not limited in its application to the details of construction and the arrangement of components set forth in the previous description or illustrated in the drawings. The system and methods of assembly disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into a description of the metes and bounds of the system. Any functional language in the drawings is a reference to the system being configured to perform the recited function, and structures shown or described in the drawings are to be considered as the system comprising the structures recited therein. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B, and C, such as AB, AC, BC, or ABC, for example.

“Substantially” and “approximately” when used in conjunction with a value encompass a difference of 5% or less of the same unit and/or scale of that being measured (e.g., degrees, volume, mass, distance).

As used herein, “can” or “may” or derivations thereof are used for descriptive purposes only and is understood to be synonymous and/or interchangeable with “configured to” when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, are not intended to limit the scope of some embodiments of the system.

It will be appreciated by those skilled in the art that while the system has been described above in connection with some embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

What is claimed is:

1. A system comprising:
a grounding fastener,
an antenna, and
a heat sink;
wherein the grounding fastener is configured to electrically couple the antenna to the heat sink; and
wherein the grounding fastener is configured to mechanically couple the antenna to the heat sink.

2. The system of claim 1,
wherein the grounding fastener is configured to electrically ground the antenna to the heat sink.

3. The system of claim 1,
wherein the grounding fastener comprise a first grounding fastener and a second grounding fastener.

4. The system of claim 3,
wherein the first grounding fastener is configured to electrically couple to the second grounding fastener; and
wherein the first grounding fastener is configured to mechanically couple to the second grounding fastener.

5. The system of claim 4,
wherein the first grounding fastener is configured to contact the antenna on an antenna first side when the first grounding fastener is coupled to the second grounding fastener; and
wherein the second grounding fastener is configured to contact the antenna on an antenna second side when the first grounding fastener is coupled to the second grounding fastener.

6. The system of claim 4,
further comprising a printed circuit board;
wherein the second grounding fastener is configured to electrically couple the printed circuit board to the heat sink.

7. The system of claim 4,
further comprising a heat spreader.

8. The system of claim 7,
wherein the second grounding fastener is configured to electrically couple the antenna to the heat spreader.

9. The system of claim 7,
wherein the second grounding fastener is configured to electrically couple the heat sink to the heat spreader.

10. The system of claim 4,
further comprising a middle heat spreader and a bottom heat spreader;
wherein the second grounding fastener is configured to electrically couple the heat sink to the middle heat spreader; and
wherein the second grounding fastener is configured to electrically couple the heat sink to the bottom heat spreader.

11. The system of claim 10,
wherein the second grounding fastener is configured to electrically couple the antenna to the heat sink, the middle heat spreader, and the bottom heat spreader.

12. The system of claim 6,
further comprising a heat spreader.

13. The system of claim 12,
wherein the second grounding fastener is configured to electrically couple the antenna to the heat spreader.

14. The system of claim 13,
wherein the heat spreader comprises a middle heat spreader and a bottom heat spreader.

15. The system of claim 14,
wherein the second grounding fastener is configured to electrically couple the heat sink to the middle heat spreader; and
wherein the second grounding fastener is configured to electrically couple the heat sink to the bottom heat spreader.
